(19) United States
(12) Patent Application Publication
(10) Pub. No.: US 2006/0107590 A1
(43) Pub. Date: May 25, 2006

(54) Plant substrate, method of making same, and use thereof

(76) Inventor: Alireza Kharazipour, Gottingen (DE)

Correspondence Address: COHEN, PONTANI, LIEBERMAN & PAVANE, Suite 1210, 551 Fifth Avenue, New York, NY, 10176, US

(21) Appl. No.: 11/252,930

(22) Filed: Oct. 18, 2005

(30) Foreign Application Priority Data
Oct. 20, 2004 (DE) 10 2004 051 233.7

(51) Int. Cl. A01G 31/00

(52) U.S. Cl. 47/59 S

(57) ABSTRACT

A plant substrate, e.g., for the cultivation of ornamental plants, vegetables, or trees, contains red-rot wood that has been mechanically or thermomechanically pulped. Additives of the following types can be mixed with the pulped wood: pesticides, e.g., fungicides and bactericides, wetting agents, dyes, stabilizers, odor inhibitors, fragrances, peat, coal, charcoal, lignite, activated carbon, organic powders, and pH regulators.

### BACKGROUND OF THE INVENTION

1. Field of the Invention

The present invention relates to a plant substrate containing a plurality of fractions of red-rot wood, method of making the same, as well as the use thereof.

2. Description of the Related Art

In view of the increasing scarcity of peat, possible peat substitutes are very intensively sought, especially in Europe. Commercial gardening alone requires 10 million cubic meters of peat annually for cultivated plant substrates.

At present red-rot wood can be marketed, if at all, only with considerable price discounts. Spruce, which is the most important species of tree in Germany, is infected with the red rot fungus (Heterobasidion annosum) to the extent of about 20% of the spruce timber harvest. The decomposition of the wood begins from inside the trunk and is recognizable by the dirty brown color. The outer zones of the trunk often show less infection or no infection at all.

### SUMMARY OF THE INVENTION

Surprisingly, it was found that red-rot wood can be processed into a good plant substrate. The infection has no negative effects on the properties of the wood as a plant substrate.

Therefore, the present invention provides a plant substrate comprising a plurality of fractions of red-rot wood. The red-rot wood may be spruce wood infected by a red rot fungus. The plant substrate may further comprise a plant growth acceptable additive. The plant growth acceptable additive may be a pesticide, a wetting agent, a dye, a stabilizer, an odor inhibitor, a fragrance agent, peat, soil, coal, charcoal, lignite, activated carbon, organic powder, a fertilizer, and a pH regulator.

The present invention also provides a method of making a plant substrate. The method comprises: fractionalizing a segment of red-rot wood into a plurality of fractions; and mixing a plant growth acceptable additive with the plurality of fractions.

The present invention further provides a method of growing a plant comprising: contacting the plant with a plant substrate comprising a plurality of fractions of red-rot wood. The plant may be an ornamental plant, a vegetable, or a tree.

Other objects and features of the present invention will become apparent from the following detailed description. It is to be understood, however, that the detailed description and examples are provided solely for purposes of illustration and not as a definition of the limits of the invention, for which reference should be made to the appended claims.

### DETAILED DESCRIPTION OF THE PRESENTLY PREFERRED EMBODIMENTS

It has been found to be advantageous during the recovery of the red-rot wood to separate the outer zones of the trunk that have not yet been infected. Boards cut from the intact outer zones can be used as industrial wood in the woodworking industry. This tangential stripping of the trunks can be accomplished, for example, with rift saws. The inner, infected layers are then pulped, which can be accomplished with significantly less power consumption than in the case of healthy wood. The pulping can be carried out in an ordinary garden shredder, but other type of pulping equipment are also suitable, for example, a refiner or a thermal screw press, as described in EP 0 472 684 B1.

According to the requirements, well-defined fractions can be screened out of the pulped material.

The plant substrate produced in accordance with the invention has a high water holding capacity and good air permeability. It is a good ion exchanger and therefore can serve as a storehouse for macronutrients. Germinating power and plant growth are promoted. The supply of nutrients required for plant growth, especially nitrogen, can be adjusted with respect to time. Waterlogging does not occur, and consolidation does not take place.

On the whole, a slowing of evaporation is observed. The pH of the plant substrate is about 4.3-4.5. Therefore, the pH range required for the cultivated plants can be optimally adjusted by fertilizing with lime, as in the case of peat. The content of ingredients that inhibit plant growth is very low.

The plant substrate of the invention has the additional advantage that it shows no evolution of heat due to microbial reactions, even after prolonged storage. Of course, the prerequisite for this is that no additional organic substances that would allow such reactions are added to the plant substrate. This is the reason that, in the recovery of red-rot woods, the uninfected healthy outer layers of the trunk should be removed as far as possible, as described above, since if they are not removed, they promote, as organic material, microbial heating of the plant substrate. The amount of organic material in the plant substrate should, if possible, not exceed 20 vol. %, since perceptible heating can start to occur above this limit.

By avoiding heating, shipment of the plant substrate in large barrels or storage in large amounts is possible without undesirable heating or even spontaneous combustion occurring. Previously known plant substrates are often subject to this type of undesired evolution of heat.

Customary mineral fertilizers can be added to the plant substrate, for example, nitrogen fertilizers, phosphate fertilizers or potash fertilizers. If possible, the mineral fertilizers should not contain any organic additives.

The present method offers the possibility of converting the raw material red-rot wood, which could not previously be successfully utilized, into a marketable product with better properties than the peat that has been used until now. The structure of the wood fibers can be influenced by the pulping method that is used. For example, the fiber diameter and the fiber length can be influenced by adjustment of the grinding disk clearance of the refiner.

The following examples are provided for further illustration, but not for limitation, of the present invention.

### EXAMPLE 1

Spruce trunks affected with red rot were cut to a length of 2.5 m and cut tangentially from the outside to the inside with a rift saw. The still intact outer boards were used as woodworking material. The inner, infected regions were pulped in a shredder. The shredder used for the pulping was a twin-screw retruder manufactured by the company Intertoresa AG. The pulping was carried out thermomechanically under high pressure at 80° C. The fibers produced in this way had the following properties:

| | |
|---|---|
| moisture content | 26.5% w/w |
| dry residue | 73.5% w/w |
| bulk density (dry) | 96 kg/m³ |
| water holding capacity | 377 g/100 g dry matter |
| total pore volume | 93% v/v |
| water holding capacity | 36% v/v |
| air holding capacity | 57% v/v |
| ash | 0.2% w/w |
| organic substance | 99.8% v/v |
| shrinkage value | 2% |
| cation exchange capacity | 16.7 mmoles/1 eq/100 g = cmolesc × kg |
| (after Mehlich, exchange | |
| at pH 8.2) | |
| particle-size distribution | >8 mm about 1 wt. % |
| | 5-8 mm about 5 wt. % |
| | 2-5 mm about 20 wt. % |
| | <2 mm about 74 wt. % |
| final product temperature | about 30° C. (after 7 days) |
| fungal infection | no detectable fungal infection |

### EXAMPLE 2

The fibers produced as described in Example 1 were processed into a germination substrate by the addition of 2 vol. % of a nitrogen/phosphate/potash fertilizer. This substrate was subsequently used in a plant germination test. The pH was adjusted by adding 1 g/L of CaCO₃.

Particle size of the final product:

| | |
|---|---|
| particle-size distribution | >8 mm about 1 wt. % |
| | 5-8 mm about 5 wt. % |
| | 2-5 mm about 20 wt. % |
| | <2 mm about 74 wt. % |
| final product temperature | about 35° C. (after 7 days) |
| fungal infection | no detectable fungal infection |

### EXAMPLE 3

As in Example 2, a germination substrate was produced from 33 vol. % of the product of Example 1, mixed with 33 vol. % of spruce fresh wood chips with bark and 33 vol. % of the screened material “spruce pulp sticks” without bark. 2 vol. % of fertilizer were added as in Example 2. The final product was pigmented with 0.5 vol. % lignite.

To produce a germination substrate, the following were added:—

33 vol. % of thermomechanical pulp of spruce wood chips with spruce bark, and—

33 vol. of the screened material “spruce pulp sticks” without bark.

Particle size of the final product: medium.

| | | |
|---|---|---|
| particle-size distribution | >8 | mm about 10 wt. % |
| | 5-8 | mm about 15 wt. % |
| | 2-5 | mm about 20 wt. % |
| | <2 | mm about 55 wt. % |

### EXAMPLE 4

As in Example 1, a germination substrate was produced from 50 vol. % of the product of Example 1 and 50 vol. % of thermomechanical pulp of spruce wood chips without bark. 2 vol. % of fertilizer were added as in Example 2. The product was pigmented as in Example 3.

To produce a germination substrate, the following were added:—

50 vol. % of thermomechanical pulp of spruce wood chips with spruce bark.

Particle size of the final product: coarse.

| | | |
|---|---|---|
| particle-size distribution | >8 | mm about 10 wt. % |
| | 5-8 | mm about 20 wt. % |
| | 2-5 | mm about 20 wt. % |
| | <2 | mm about 55 wt. % |

### EXAMPLE 5

The germination substrates of Examples 1 to 4 were used in a plant germination test with Chinese cabbage. For this purpose, all germination substrates were mixed with 30% standard soil (TKS).

The increase in fresh mass after a period of 3 weeks was determined.

All of the germination substrates were mixed with 30 vol. % of standard soil. The tests yielded the following results:

| Germination | | | | | |
|---|---|---|---|---|---|
| substrate according | FM (g/pot) | | FM (x) | FM (r) | gas |
| to Example: | WH1 | WH2 | [g] | [%] | phase |
| Standard soil | 14.3 | 13.8 | 14.1 | 100 | no |
| 1 | 11.4 | 12.3 | 11.9 | 84 | no |
| 2 | 13.1 | 13.1 | 13.1 | 93 | no |
| 4 | 14.1 | 14.2 | 14.2 | 101 | no |
| 3 | 12.7 | 12.8 | 12.8 | 91 | no |

FM = fresh mass
WH = repetition
(x) = mean value
(r) = standard deviation

### EXAMPLE 6

Spruce trunks affected with red rot were cut to a length of 5 m and crushed in a crusher. The machine used for pulping was a twin-screw retruder manufactured by the company Intertoresa AG. The pulping was carried out thermomechanically under high pressure at 95° C. The fibers produced in this way had the following properties:

| | |
|---|---|
| moisture content | 28% w/w |
| dry residue | 73.5% w/w |
| bulk density (dry) | 98 kg/m3 |
| water holding capacity | 377 g/100 g dry matter |
| total pore volume | 94% v/v |
| water holding capacity | 38% v/v |
| air holding capacity | 56% v/v |
| ash | 0.4% w/w |
| organic substance | 99.6% v/v |
| shrinkage value | 2% |
| cation exchange capacity (after | 16.7 mmoles/1 eq/100 g = |
| Mehlich, exchange at pH 8.2) | cmolesc × kg |

The fibers produced as described in Example 6 were processed into a germination substrate by the addition of 3 vol. % of a nitrogen/phosphate/potash fertilizer. This substrate was subsequently used in a plant germination test. The pH was adjusted by adding 1 g/L of CaCO3.

The germination substrate of Example 6 were used in a plant germination test with Chinese cabbage. The increase in fresh mass and dry matter after a period of 3 weeks was determined. The following results were obtained:

| | WH 1 (g/pot) | | WH 2 (g/pot) | | WH 3 (g/pot) | |
|---|---|---|---|---|---|---|
| | FM | TM | FM | TM | FM | TM |
| Germination substrate | 27.4 | 1.1 | 29 | 1.1 | 28.9 | 1.2 |
| in accordance with | | | | | | |
| Example 6 | | | | | | |
| TKS 1 | 32.1 | 1.1 | 43.2 | 1.8 | 43.1 | 1.6 |

| | |
|---|---|
| particle-size distribution | >8 mm about 2 wt. % |
| | 5-8 mm about 7 wt. % |
| | 2-5 mm about 22 wt. % |
| | <2 mm about 69 wt. % |
| final product temperature | about 25° C. (after 7 days) |
| fungal infection | no detectable fungal infection |

FM = fresh mass
TM = dry matter
WH = repetition

The invention is not limited by the embodiments described above which are presented as examples only but can be modified in various ways within the scope of protection defined by the appended patent claims.

I claim:

1. A plant substrate comprising a plurality of fractions of red-rot wood.

2. The plant substrate of claim 1 wherein the red-rot wood is spruce wood infected by a red rot fungus.

3. The plant substrate of claim 1 further comprising a plant growth acceptable additive.

4. The plant substrate of claim 3 wherein the plant growth acceptable additive is selected from the group consisting of a pesticide, a wetting agent, a dye, a stabilizer, an odor inhibitor, a fragrance agent, peat, soil, coal, charcoal, lignite, activated carbon, organic powder, a fertilizer, and a pH regulator.

5. The plant substrate of claim 4 wherein the pesticide is selected from the group consisting of a fungicide and a bactericide.

6. The plant substrate of claim 4 wherein the fertilizer is a mineral fertilizer.

7. The plant substrate of claim 6 wherein the mineral fertilizer is selected from the group consisting of a nitrogen fertilizer, a phosphate fertilizer, and a potash fertilizer.

8. The plant substrate of claim 6 wherein the mineral fertilizer is free of any organic additive.

9. The plant substrate of claim 4 wherein the pH regulator is lime.

10. A method of making a plant substrate comprising fractionalizing a segment of red-rot wood into a plurality of fractions and mixing a plant growth acceptable additive with the plurality of fractions.

11. The method of claim 10 wherein the step of fractionalizing is carried out by pulping the segment of red-rot wood mechanically or thermomechanically.

12. The method of claim 11 wherein the pulping is carried out with a shredder.

13. The method of claim 11 wherein the pulping is carried out in a thermal screw press.

14. The method of claim 11 wherein the pulping is carried out in a refiner.

15. The method of claim 10 wherein the plant growth acceptable additive is selected from the group consisting of a pesticide, a wetting agent, a dye, a stabilizer, an odor inhibitor, a fragrance agent, peat, coal, charcoal, lignite, activated carbon, organic powder, a fertilizer, and a pH regulator.

16. A method of growing a plant comprising contacting the plant a plant substrate comprising a plurality of fractions of red-rot wood.

17. The method of claim 16 wherein the plant is selected from the group consisting of an ornamental plant, a vegetable, and a tree.

18. The method of claim 16 wherein the red-rot wood is spruce wood infected by a red rot fungus.

19. The method of claim 16 wherein the plant substrate further comprises comprising a plant growth acceptable additive.

20. The method of claim 19 wherein the plant growth acceptable additive is selected from the group consisting of a pesticide, a wetting agent, a dye, a stabilizer, an odor inhibitor, a fragrance agent, peat, coal, charcoal, lignite, activated carbon, organic powder, a fertilizer, and a pH regulator.
